(19) United States
(12) Patent Application Publication
(10) Pub. No.: US 2008/0149420 A1
(43) Pub. Date: Jun. 26, 2008

(54) Vehicle mountable elevating platform

(76) Inventor: Daniel P. Cheatham, Crestwood, KY (US)

Correspondence Address: David W. Carrithers;CARRITHERS LAW OFFICE, PLLC, One Paragon Centre, 6060 Dutchman's Lane, Suite 140, Louisville, KY, 40205, US

(21) Appl. No.: 11/998,998

(22) Filed: Dec. 3, 2007

Related U.S. Application Data
(60) Provisional application No. 60/872,246, filed on Dec. 1, 2006.

(51) Int. Cl. B66F 7/04; B60R 9/06

(52) U.S. Cl. 182/63.1; 280/769

(57) ABSTRACT

A collapsible telescoping platform apparatus readily mountable on and transported by a motorized vehicle and includes a platform for supporting the user on a tower that is extendible and retractable in a vertical direction to thereby raise and lower that user as desired by that user of the apparatus. The tower projects upwardly from a rigid base structure that detachably connects to a conventional vehicle mounted trailer hitch.

### CROSS REFERENCE TO RELATED APPLICATIONS

This application claims priority from U.S. Provisional Application Ser. No. 60/872,246 filed on Dec. 1, 2006 and is incorporated by reference herein in its entirety. Reference to documents made in the specification is intended to result in such patents or literature cited are expressly incorporated herein by reference, including any patents or other literature references cited within such documents as if fully set forth in this specification.

### FIELD OF INVENTION

This invention related to vehicle mounted portable platforms for hunters, construction workers and the like, and to the construction of the apparatus and removably mounting of the apparatus on a motorized vehicle.

### BACKGROUND OF THE INVENTION

Mobile platforms that can raise and lower the hunter are know and by way of example reference may be had to the following U.S. patents and published applications: U.S. Publication 2005/0274573 published Dec. 15, 2005, U.S. Pat. No. 6,460,653 granted Oct. 8, 2002, and U.S. Pat. No. 6,439,635 granted Aug. 27, 2002.

Each of the foregoing references teaches a platform supported by a scissor type jack carried by a wheeled vehicle which in the '635 patent is a trailer, and an all terrain vehicle, (“ATV”) in the other references. In the above published application the stand is mounted don the rear carrier above the rear axle of the ATV and in U.S. Pat. No. 6,460,635 the seat for the operator of the vehicle is supported by the jack.

Other pertinent patents and published applications are as follows: U.S. Patent publication 2003/0155179 published Aug. 21, 2003 by A. McDougal, U.S. Pat. No. 6,978,862 granted Dec. 27, 2005 by D. W. Cotton Sr. U.S. Pat. No. 6,739,428 granted May 25, 2004 by C. R. Holmes et al., U.S. Pat. No. 6,550,575 granted Apr. 22, 2003 by C. A. Spencer et al., U.S. Pat. No. 5,409,081 granted Apr. 25, 1995 by J. F. Reeves, and U.S. Pat. No. 5,042,614 granted Aug. 27, 1991 by R. P. Rainey.

As is clearly evident from the foregoing references it is known to have an elevated stand for a hunter where such stand in mounted on a mobile vehicle but in all of the instances known to the applicant the hunters platform is located essentially entirely within the outer perimeter of the vehicle and thus the vehicle becomes fully dedicated to that usage. Also mounting and dismounting the known apparatus is complicated and time consuming.

Mobile person elevating devices are known that are used in what is commonly referred to as box stores. In these instances goods are stacked one upon another in stacks so high that the items on upper part of the stack cannot be reached or the goods are located on shelving that extends upwardly beyond the reach of an individual.

Also known are the forklift trucks that are commonly used in lumber yards and warehouses.

These known person elevating devices use a multi-section vertically disposed unit that can be raised and lowered by power means actuated by the user of the apparatus and many of the fork lift trucks use multi-section lift towers.

### SUMMARY OF INVENTION

The present invention provides an apparatus that is detachably mountable on a vehicle so as to be transported thereby from location to another. The vehicle has a trailer towing hitch mounted thereon and means for detachably connecting the base member to the hitch and thereby mounting the apparatus on the vehicle. More particularly, the platform apparatus utilizes a conventional trailer hitch having a square socket and including a hitch coupling member secured to the base member and means detachably connecting the coupling member to the trailer hitch.

The elevated platform apparatus comprises a rigid base member having a first elongate tower section rigidly secured thereto and projecting upwardly therefrom. A further elongate tower section is movably mounted on the first tower section for reciprocal movement therealong and includes means guiding the further tower section along the predetermined path. An occupant supporting platform is mounted on the movable tower section.

An object of the present invention is provide a simple platform apparatus that can be readily raised and lowered at will of the user and detachably mounts on a vehicle.

A further principal object of the present invention is to provide a person elevating apparatus that is collapsible whereby the footprint thereof in the collapsed state is smaller than when in the operative state.

A further object of the present invention is to provide a mobile person elevating apparatus that when mounted on the vehicle it is located in the most part outboard of the perimeter of such vehicle.

A further principal object of the present invention is to provide a person platform that can be raised and lowered as desired and which can be readily attached to a vehicle.

In keeping with the forgoing there is provided in accordance with one aspect of the present invention an occupant elevating unit mountable on a motorized vehicle comprising a base member; means for mounting the base member on the vehicle; an occupant elevating unit having a vertically disposed elongate element reciprocally mounted on the base for movement from one to the other of a first lower position and a second elevated position along a predetermined path; an occupant supporting platform mounted on the reciprocally mounted element for movement therewith along the path; and power means connected to the reciprocally mounted element for moving the same from the first position to the second position.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a rear side oblique view of an all terrain vehicle with a hunters stand of the present invention mounted thereon and in a collapsed traveling state;

FIG. 2 is similar to FIG. 1 showing the platform in partially unfolded for use state prior to being elevated;

FIG. 3 is similar to FIG. 2 but showing the platform in a partially elevated state;

FIG. 4 is similar to FIGS. 2 and 3 but illustrating the platform in a fully elevated state;

FIG. 5 is a rear oblique view showing the platform in a fully elevated state;

FIG. 6 is a rear side oblique view illustrating the platform of the present invention in it's collapsed state and mounted on the rear end of a pick-up truck;

FIG. 7 is similar to FIG. 6 but taken from a different angle;

FIG. 8 is an oblique view similar to FIG. 6 with the platform in an unfolded operative state prior to being elevated;

FIG. 9 is a partial oblique view of the lower end portion of the apparatus illustrating the means mounting the same on the vehicle

FIG. 10 is a partial oblique view showing a seat for the user in a folded states and means for supporting the same.

FIG. 11 is a top oblique view showing the multi-element elevating unit and mechanism to elevate the same;

FIG. 12 is an oblique view of the upper end showing the cable arrangement used to elevate the elevating unit;

FIG. 13 shows the cable arrangement and anchoring of the same at the lower end;

FIG. 14 is a bottom oblique view of the support base for the apparatus and means for mounting the same on a vehicle;

FIG. 15 is an oblique view of one of a pair of outriggers used to support the apparatus in an operative state;

FIG. 16 is an oblique view of the uppermost on of the ladder like elements of the elevating unit;

FIG. 17 is an oblique view of the platform that supports a person on the element shown in FIG. 16;

FIGS. 18-65 are color photocopies of the above-invention showing different views and features.

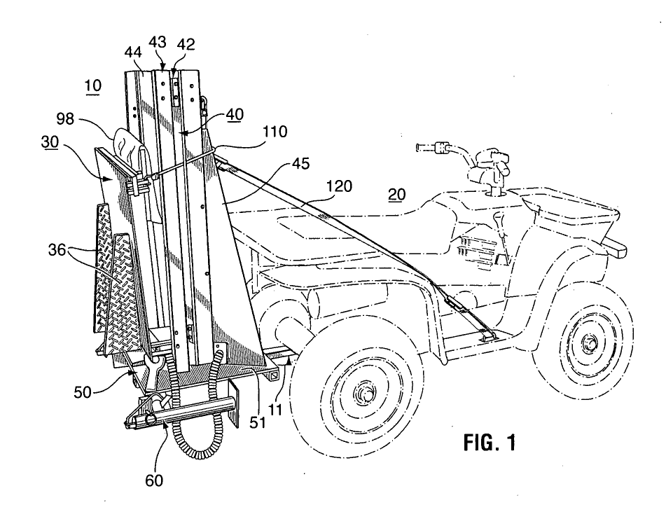

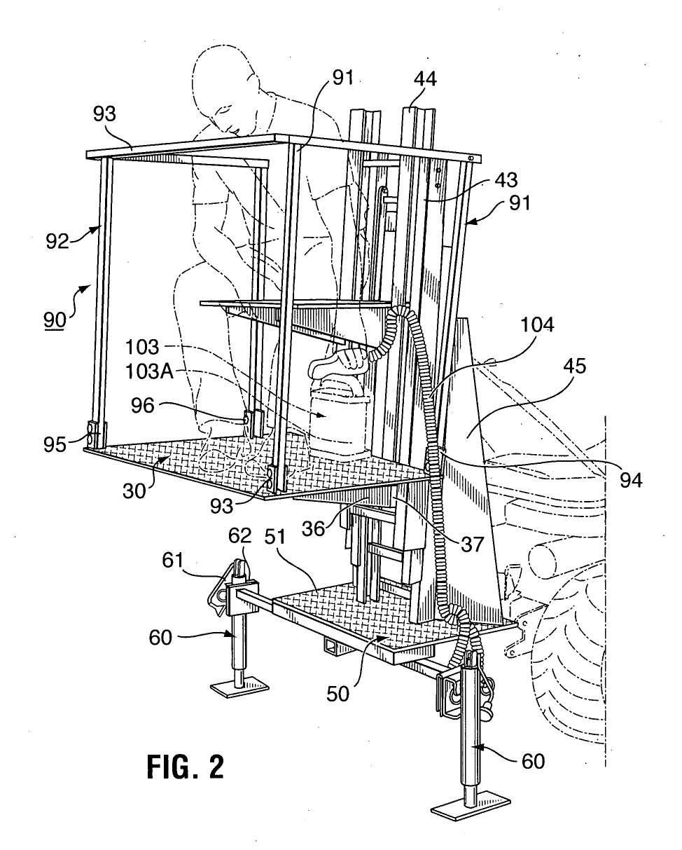

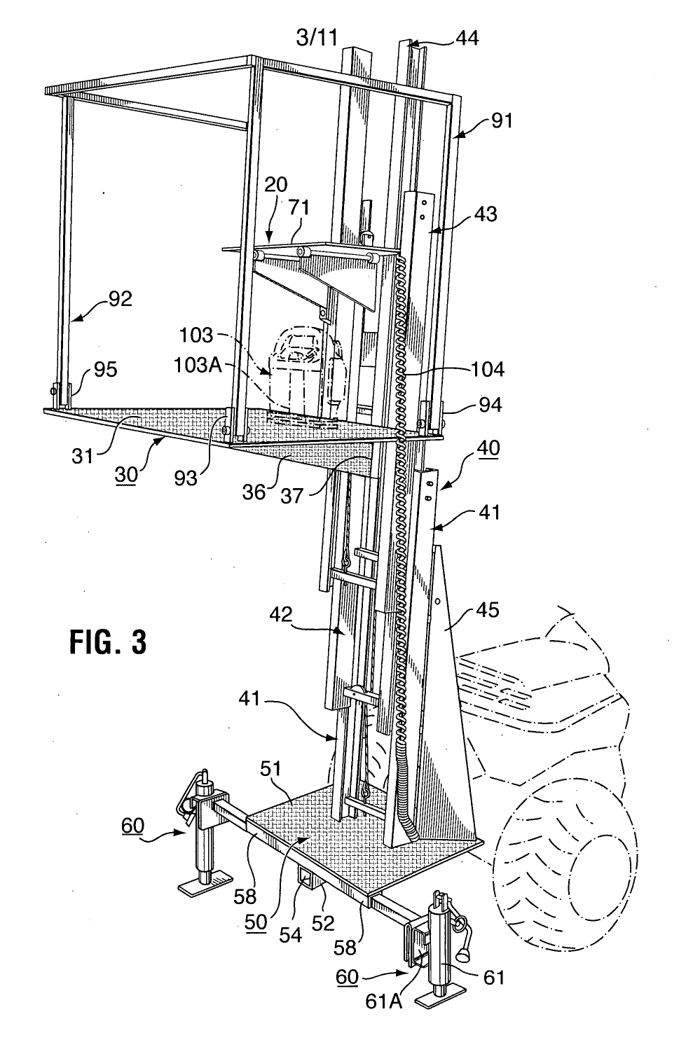

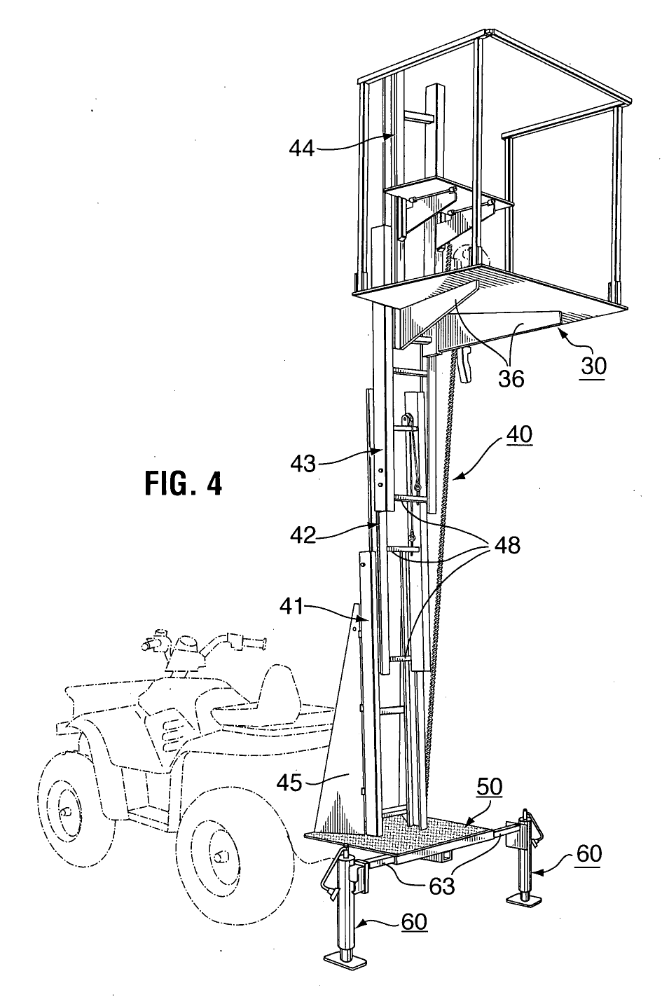

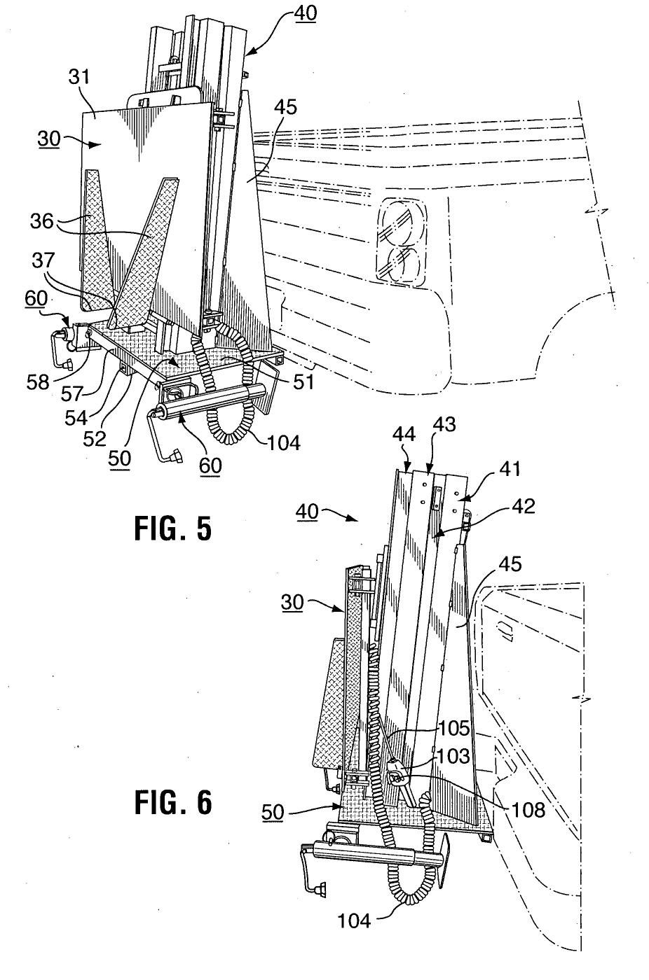

### DETAILED DESCRIPTION OF PREFERRED EMBODIMENT

Illustrated in the drawings is an apparatus 10 mounted on a mobile vehicle 20. The stand has been designed for use by deer hunters and is described and illustrated herein in that context. It however become obvious that it could have many other applications.

The apparatus is readily mountable on and transported by a motorized vehicle and includes a platform 30 for supporting the user on a tower 40 that is extendible and retractable in a vertical direction to thereby raise and lower that user as desired by that user of the apparatus. The tower projects upwardly from a rigid base structure 50 that detachably connects to a conventional vehicle mounted trailer hitch 11.

The vehicle illustrated in the drawings in one instance is an all terrain vehicle (ATV) and in another instance a pick-up truck. The preferred mounting is via a conventional square socket type trailer hitch and this permits mounting the apparatus on any vehicle so equipped e.g a van, an automobile, a SUV, an off road vehicle, a pick-up truck and the like. It will be readily apparent to those skilled in the art that the apparatus maybe readily adapted to mounting on a vehicle via other type trailer hitches and/or on the bumper attached to the vehicle.

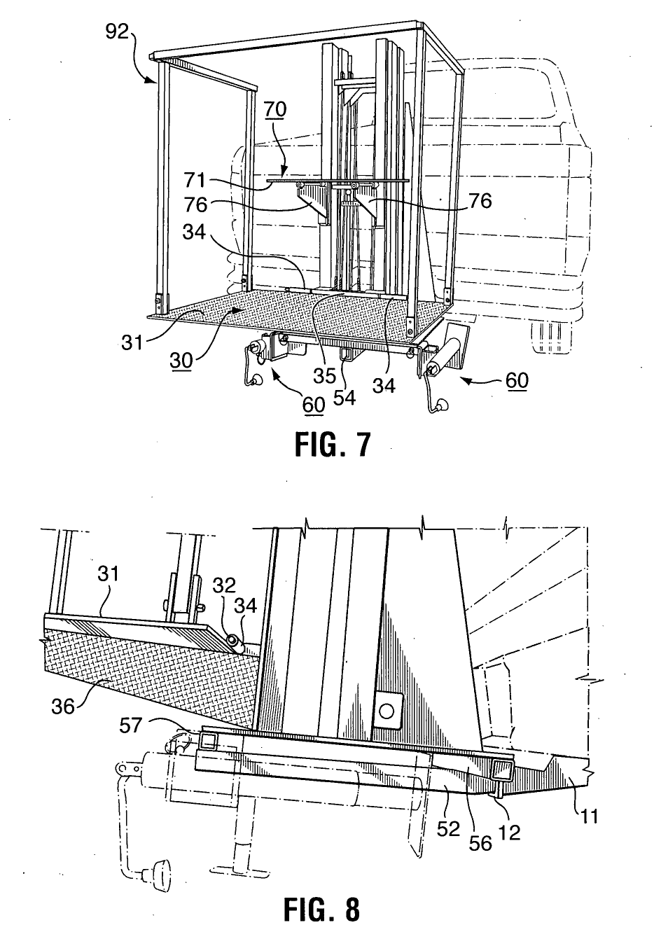

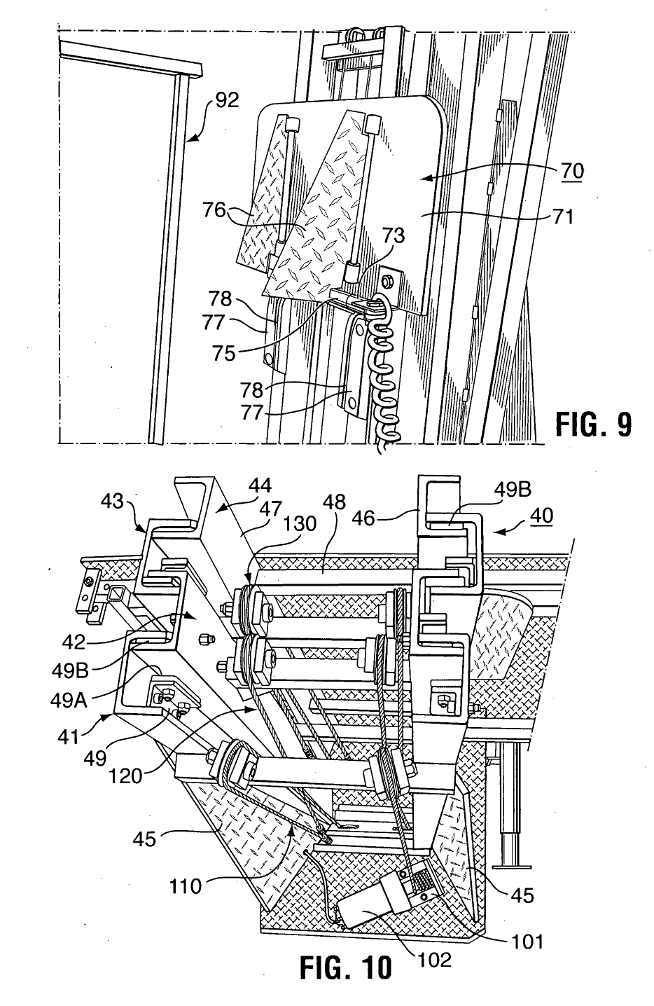

The base 50 (see FIGS. 6, 7,9 and 14) comprises a rigid plate 51 having an elongate square tubular mounting member 52 securely fixed thereto on the underside thereof. The member 52 has a leading end 53 that is insertable into the trailer hitch socket thereby detachably mounting the apparatus on the vehicle. The elongate square tubular member is mounted on the underside of the rigid base plate 51 and if desired it can provide or be provided with a socket 54 at the trailing end for receiving therein a trailer hitch coupling member for towing a trailer.

The plate 51 has reinforcing cross-members 56, 57 at respective leading and trailing edges and these are transverse to the member 52.

Alternative to insertion of the leading end of member 52 into the hitch socket the connection maybe via a separate elongate, square in outline cross-section, member that projects partially into the member 52 and partially into the square socket portion of the trailer hitch.

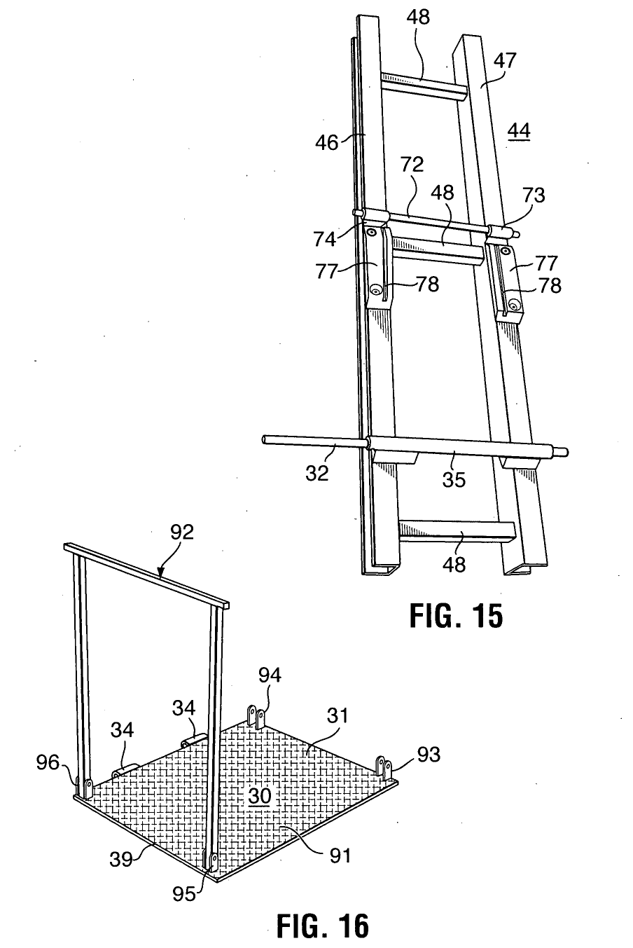

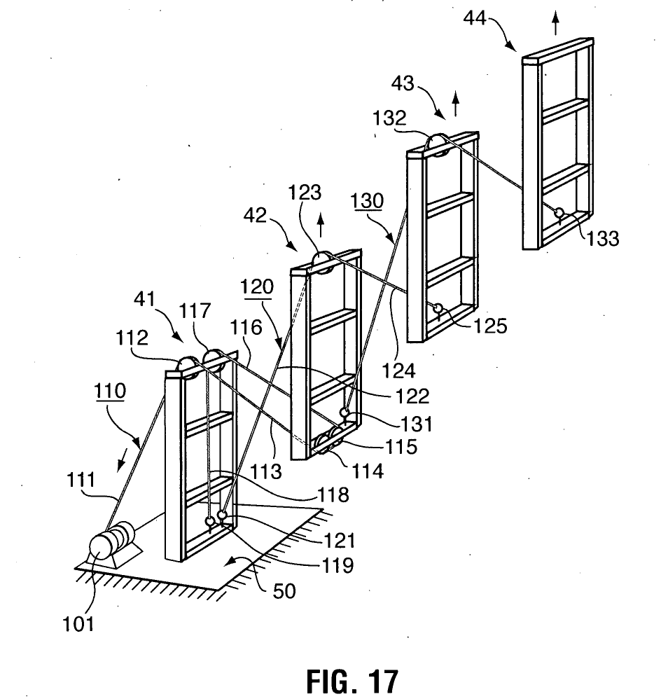

The base 50 has a pair of outriggers 60 pivotally and slidably attached thereto and are movable from one to the other of a raised and retracted traveling position and an extended and lowered ground engaging stabilizing position. Each outrigger (see FIG. 15) has a screw jack 61 pivotally attached to a plate 62 on one end of a of an elongate square bar 63 which has spaced apart recesses or holes 64, 65. The bar 63 slidably fits into the member 57 on the base plate 51 and a pair of locking pins 58 on the member 57 project into the hole 64 or 65 depending upon the retracted or extended position locking the outrigger in that position. The pins 58 maybe self locking for example by having a c-ring of spring material located partially in a groove in the pin or maybe spring biased to a locking position.

The tower 40 has respective first, second, third and fourth rigid elongate sections 41, 42, 43, and 44 with section 41 being fixedly secured to the plate 51 and projecting upwardly therefrom. The first section is reinforced by a pair of gusset plates 45. Each section 41, 42, 43 and 44 is a ladder like rigid unit comprising a pair of laterally spaced apart channel members 46, 47 interconnected by cross members or stringers 48. The second section 42 is slidably mounted on the first fixed in position section 41, the third section 43 slidably mounted on the second section and the fourth section 44 is slidably mounted on the third section. The ladder like section allows one to scale up and down the vertically extended tower should that become necessary due to for example a malfunction of a power means, to be described hereinafter, that extends and lowers the tower.

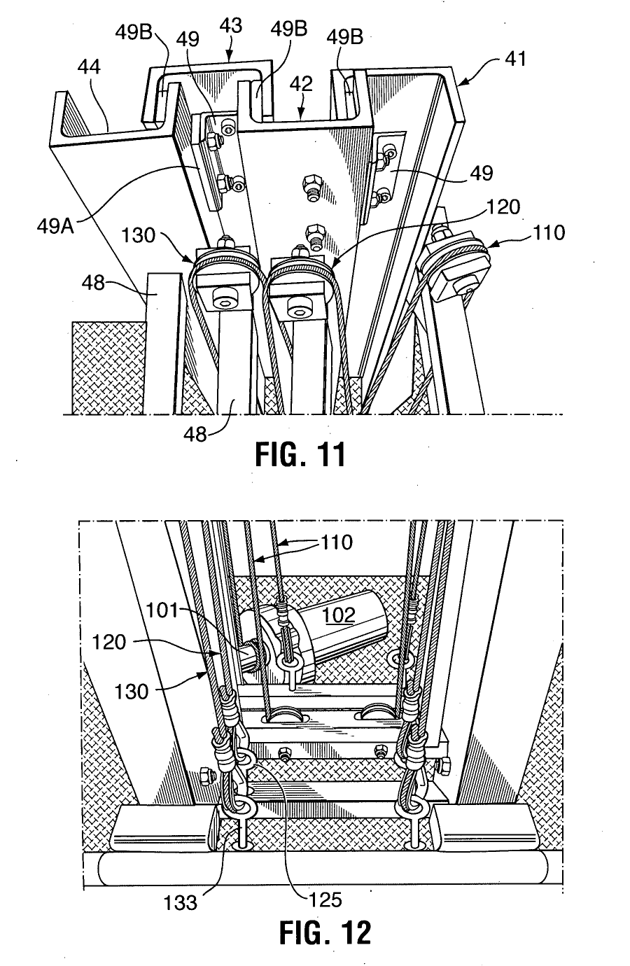

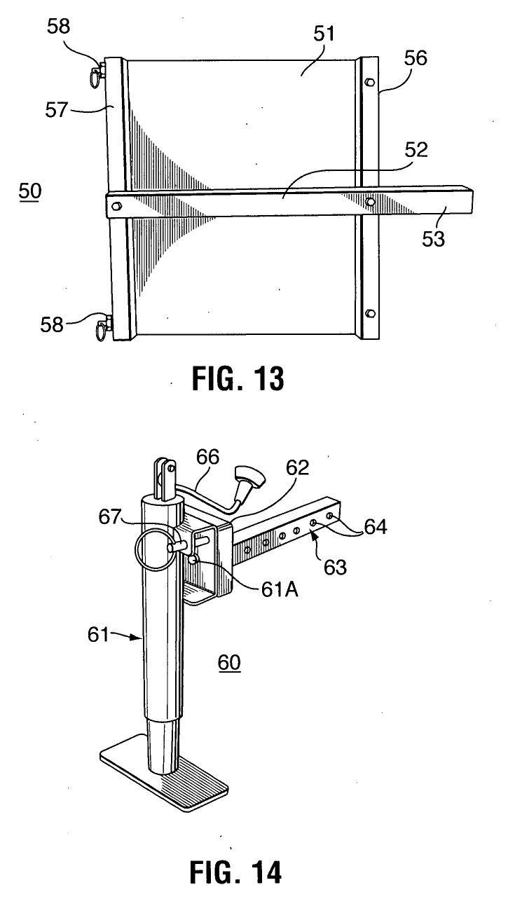

Each ladder like section has elongate channels arranged relative to the next section adjacent thereto as to provide means for slidably mounting one section on the next. More particularly the open face of the channels on one section are in back-to-back relation on one unit and in face-to-face relation on the next adjacently disposed section. The channel member of section 41 have the open faces thereof in face-to-face relation and this orientation also applies to the section 43. On the other hand the channels of each of the respective tower sections 42 and 44 have the opposite orientation wherein the webs of the channels are in back-to-back relation. Brackets such as brackets 49 (see FIG. 11) are suitably positioned in the channels to guide the sliding movement of the sections limiting the same to predetermined paths which in the embodiment illustrated consists of parallel paths equal in number to the number of movable sections.

The tower described in the forgoing has three movable sections but obviously may have only one or two movable sections or more than three if so desired. Also instead of having the sections slidably mounted one upon the other it is contemplated such arrangement could readily be replaced by a multi-section telescopic post with suitable power means such as hydraulic or pneumatic means to raise and lower the same.

In order to lighten the load that is carried by the hitch on the vehicle the ladder like units are made of light weight material such as aluminum, magnesium or the like.

The tower section 44 reaches the highest elevation and has the occupant supporting platform 30 attached thereto. The platform includes a plate 31 that is hingedly attached alone one edge thereof to the movable section 44 and is movable from one to other of a first storage position where it is disposed generally in a vertical plane lying flatwise against the tower section 44 and a second position wherein it is disposed generally perpendicular thereto (i.e. in a horizontal plane) providing a platform on which the user can stand. The hinge means includes a pin 32 that passes through axially aligned sleeves 34, 35 on the respective members The pivot axis of the hinge means is spaced vertically a selected distance from the base plate 51. The plate 31 has a pair of laterally spaced apart gusset plates 36 secured thereto and projecting downwardly from the underside thereof. These plates diverge from one another in direction away from the tower and have a rear edge 37 that abuts against the tower and determines the horizontal attitude for the operative position of the platform.

A seat 70 for the occupant is provided and is located at a suitably selected height above the platform. The seat comprises a plate 71 hingedly attached by a pin 72 passing through aligned sleeves 73, 74 on the tower section 44 and a sleeve 75 on the plate 71. The plate 71 has spaced apart pair of plates 76 hingedly attached and depending downwardly from the underside of the seat. The plates are aligned with a respective one of a pair of abutment plates 77 on the channel members. The plates 77 each have a groove 78 for receiving therein a rear edge of the plate associated therewith. The plates 77 self align with the groove as the seat is pivoted to its operative position. The plate 71 can of course be omitted in favor of a collapsible aluminum lawn chair if one so desires.

A cage 90 is provided for the occupant on the platform and consists of u-shape frames 91, 92 and a cross bar 93 that interconnects the same when then are unfolded into an operative upright position. The frame 91 is pivotally attached by pivot pins and brackets 93, 94 to the platform plate 51 and similarly the frame 92 is pivotally attached via brackets 95, 96. The pivot pins in brackets 95, 96 are spaced further from the plate 51 than those in brackets 93, 94 thereby allowing the frames to be in stacked relation upon one another on the plate 51 when the frames are folded into a cage collapsed state.

The tower sections 42, 43 and 44 are raised and lowered, relative to the fixed tower section 41, by a power system that includes a power driven winch and system of appropriately anchored cables running over sheaves strategically located on the various tower sections The tower section 42 is raised and lowered by a first cable 110 as it is wound onto and payed out from a winch drum 101 driven by an electric motor 102 and the sections 43, 44 move in unison with the tower section 42 by respective second and third cables 120, 130.

The motor is actuated by way of a hand held controller 103, connected to a battery power source, via a coiled cable 104. The battery. maybe that of the vehicle on which the apparatus is mounted or a separate battery 103A dedicated to power the winch. The controller has switch buttons 105, 106 designated respectively ‘up’ and ‘down’ for the user to control raising and lower of the tower as maybe desired. As previously mentioned should there be a malfunction or power failure the ladder like sections provides means for a person to go up or down (as maybe required) the extended (or partially extended) tower.

The first cable 110 has one end thereof secured to the winch drum 101 and from there has a first span 111 extending upwardly to and around a sheave 112 on the upper end of tower section 41 and from there a second span 113 extending downwardly passing around sheaves 114, 115 on the lower end of tower section 42 and a third span 116 continues upwardly passing around a sheave 117 on the upper end of the tower section 41 and from there extends downwardly as fourth span 118 where it terminates and is anchored to the base plate 50 as indicated at 119.

The second and third cables 120, 130 are suitably anchored and pass around strategically located sheaves on the tower section 43, 44 whereby those sections move in unison with raising and lower of tower section 42 on the fixed tower section 41.

One end of cable 120 is anchored to the base 30 as indicated at 121 with a first span 122 extending upwardly passing around a sheave 123 on the upper end of the tower section 42. From there the cable continues downwardly as a second span 124.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. An occupant elevating apparatus mountable on a motorized vehicle comprising
a base member;
means for mounting said base member on said vehicle;
means for raising and lowering a person comprising a vertically disposed elongate tower section reciprocally mounted on said base for movement from one to the other of a first lower position and a second position along a predetermined path wherein said second position at a higher elevation than said first position.
an occupant supporting platform mounted on said reciprocally mounted tower section for movement therewith along said path; and
power means connected to said reciprocally mounted tower section for moving the same from said first position to said second position.

2. An apparatus as defined in claim 1 wherein said elevating unit in multi-sectional

3. An apparatus as defined in claim 1 wherein said occupant supporting platform is hingedly connected to said reciprocally mounted element.

4. An apparatus as defined in claim 3 wherein said occupant supporting platform comprises a first plate.

5. An apparatus as defined in claim 1 including a seat for the occupant and wherein said seat is secured to said reciprocally mounted vertically disposed element and at a position spaced vertically from said platform.

6. An apparatus as defined in claim 1 including a hitch coupling means mounted on said base member.

7. An apparatus that is detachably mountable on a vehicle so as to be transported thereby from location to another, said apparatus comprising
(A) a rigid base member having a first elongate tower section rigidly secured thereto and projecting upwardly therefrom,
(B) a further elongate tower section movably mounted on said first tower section for reciprocal movement therealong and means guiding said further tower section along said predetermined path,
(C) an occupant supporting platform mounted on said movable tower section, and
(D) means detachably mounting said apparatus on a vehicle.

8. An apparatus as defined in claim 7 wherein the vehicle has a trailer towing hitch mounted thereon and means detachably connecting said base member to said hitch and thereby mounting said apparatus on the vehicle.

9. An apparatus as defined in claim 8 wherein said trailer hitch is a conventional trailer hitch having a square socket and including a hitch coupling member secured to said base member and means detachably connecting said coupling member to the trailer hitch.

10. An apparatus as defined in claim 9 wherein said hitch coupling member has an elongate, square in outline cross-section, portion that is insertable into the square socket of the trailer hitch.

11. An apparatus as defined in claim 9 including means pivotally mounting said platform on said movable tower section for movement from one to the other of respective first and second positions where in the first position the platform is disposed in a generally vertical plane and in the second a generally horizontal plane.

12. An apparatus as defined in claim 1 including a seat mounted on said movable tower section.

13. An apparatus as defined in claim 12 including means pivotally mounting said seat on said reciprocally movable tower section.

14. An apparatus as defined in claim 13 including support means for said seat, said support means including a plate pivotally attached to and depending downwardly from a lower portion of said seat as the seat pivots to generally horizontal position for supporting a person and abutment means on the movable tower section and engagable by an edge of said plate.

15. An apparatus as defined in claim 14 including a groove in said abutment having a length at least as long as said edge of the plate and aligned therewith for receiving therein such edge when the seat is pivoted downwardly to an operative position.

16. An apparatus as defined in claim 1 wherein each said tower section is an elongate ladder like rigid unit comprising a pair of spaced apart stiles and cross members interconnecting the same.

17. An apparatus as defined in claim 16 wherein said stiles are elongate channel members.
